(19) United States
(12) Patent Application Publication
(10) Pub. No.: US 2002/0130452 A1
(43) Pub. Date: Sep. 19, 2002

(54) Shock absorber and air spring assembly

(76) Inventors: Christof Behmenburg, Lauenau (DE); Stefan Narberhaus, Garbsen (DE); Holger Wehaus, Hannover (DE)

Correspondence Address: Walter Ottesen, Patent Attorney, P.O. Box 4026, Gaithersburg, MD, 20885-4026, US

(21) Appl. No.: 10/093,518

(22) Filed: Mar. 11, 2002

(30) Foreign Application Priority Data
Mar. 9, 2001 (DE) 101 11 242.4

(51) Int. Cl. F16F 9/04

(52) U.S. Cl. 267/64.23

(57) ABSTRACT

A shock absorber and air spring assembly includes an air spring and a shock absorber. The air spring has a cover, a roll-off piston and a flexible member having a lower end portion attached to the roll-off piston to form a lower rolling lobe and an upper end portion attached to the cover so as to form an upper rolling lobe. The flexible member encloses a volume of air and deflects over a spring path during operation of the assembly. The shock absorber is interposed between the cover and the roll-off piston. At least a region of the upper rolling lobe is in contact engagement with the cover over at least a portion of the spring path so as to cause the upper rolling lobe to define an elastic element facilitating a pivoting of the air spring relative to the shock absorber over the portion of the spring path.

### FIELD OF THE INVENTION

The invention relates to a shock absorber and air spring assembly which includes an air spring, a shock absorber and at least one elastic element with which a pivotability of the air spring relative to the shock absorber is achieved over at least a portion of the spring path of the air spring. The air spring includes a flexible member having an upper end attached to a cover and having a lower end which is connected to a roll-off piston while forming a lower rolling lobe. The flexible member encloses an air spring. The shock absorber includes a cylinder.

### BACKGROUND OF THE INVENTION

A shock absorber and air spring assembly of the above kind is hereinafter referred to as an air spring strut and is mounted between the vehicle body and the wheel of a motor vehicle in order to spring mount the wheel relative to the vehicle body (this function is assumed by the air spring) and to dampen the vibrations of the wheel or vehicle body (this function is assumed by the shock absorber). During the spring suspension of the wheel, the lower end (to which the air spring strut is attached) pivots relative to the upper end (to which the air spring strut is attached). The piston rod of the shock absorber is attached at the upper end of the air spring and the cylinder of the shock absorber is attached to the lower end of the air spring strut. For this reason, this can lead to the situation that the piston rod pivots relative to the cylinder of the shock absorber. As a consequence, the piston, which is attached to the piston rod, can tilt within the cylinder of the shock absorber which can lead to an unwanted increase of friction within the shock absorber. This problem is solved in modern air spring struts by an elastic element which makes possible a pivotability of the air spring to the shock absorber and therefore a pivotability of the piston rod to the cylinder of the shock absorber. Because of this pivotability, it is ensured that the piston rod and the cylinder of the shock absorber are always on one axis and therefore a tilting of the piston in the cylinder is prevented.

An air spring strut of the above-mentioned type which has such an elastic element is, for example, disclosed in German patent publication 195 08 980. In the air spring strut known from this publication, the cylinder of the shock absorber has a flange-like collar on which the elastic element in the form of an elastic ring is mounted. The roll-off piston of the air spring ends in a flange-like projection and supports itself with this projection on the elastic ring. The elastic ring makes possible a wobble-like movability of the roll-off piston of the air spring relative to the cylinder of the shock absorber and, as a consequence, a pivotability of the air spring relative to the shock absorber. In this way, a tilting of the piston in the cylinder of the shock absorber is prevented. However, it has been determined that the roll-off piston of the air spring must engage at a low point of the cylinder of the shock absorber in order to ensure an adequately large pivotability of the air spring relative to the shock absorber. The roll-off piston of the air spring includes the shock absorber. For this reason, the air spring strut known from German patent publication 195 08 980 requires, at its lower end, a large structural space which is not always available in modern motor vehicles.

### SUMMARY OF THE INVENTION

It is an object of the invention to provide an air spring strut which includes an elastic element which makes possible a pivotability of the air spring relative to the shock absorber and requires only little space at its lower end.

The shock absorber and air spring assembly of the invention includes: an air spring including: a cover, a roll-off piston; and, a flexible member having a lower end portion attached to the roll-off piston to form a lower rolling lobe and an upper end portion attached to the cover so as to form an upper rolling lobe; the flexible member enclosing a volume of air and deflecting over a spring path during operation of the assembly; a shock absorber interposed between the cover and the roll-off piston; and, at least a region of the upper rolling lobe being in contact engagement with the cover over at least a portion of the spring path so as to cause the upper rolling lobe to define an elastic element facilitating a pivoting of the air spring relative to the shock absorber over the portion of the spring path.

According to a feature of the invention, the object set forth above is achieved in that the upper end of the flexible member is attached to the cover while forming an upper rolling lobe. The upper rolling lobe lies in contact engagement with the cover at least over a portion of the spring path so that an elastic element is formed by the upper rolling lobe.

The pressure-effective area of the upper rolling lobe is, at least over a portion of the spring path of the air spring, configured to be smaller than the pressure-effective surface of the lower rolling lobe. This is done so that the upper rolling lobe lies in contact engagement with the cover at least over a portion of the spring path. In addition to the elastic element in the form of the upper rolling lobe, the air spring strut can include additional elastic elements which support a pivoting of the air spring relative to the shock absorber.

An air spring strut is known from German patent publication 20 63 448 wherein the upper end of the flexible member lies against a spring plate in order to ensure an air-tight termination of the air spring at its upper end. A pivotability of the air spring to the shock absorber is not intended by the special configuration of the upper end of the air spring. Furthermore, an air spring is known from German patent publication 198 42 733 which has a flexible member whose lower end is attached to a roll-off piston while forming a lower rolling lobe and whose upper end is attached to the cover of the air spring while forming an upper rolling lobe. However, it is not described in this publication that the air spring is supplemented by a shock absorber to form an air spring strut. Correspondingly, the upper rolling lobe assumes another function for the air spring known from this publication, namely, the function, in combination with the rolling lobe support, to elastically support the flexing forces arising with the spring movement of the air spring.

The advantage achieved with the invention is especially that the upper rolling lobe opposes with only a slight force a pivoting of the air spring relative to the shock absorber of the air spring strut so that a tension-free pivoting of the air spring is ensured. A further advantage of the invention is that the roll-off piston of the air spring can end far above the lower end of the air spring strut because the pivotability of the air spring relative to the shock absorber is generated with the aid of the upper rolling lobe. For this reason, the air spring strut needs only a small mounting space.

According to another feature of the invention, the diameter of the part of the cover on which the upper rolling lobe rolls off is, at least over a portion of the spring path of the air spring, less than the diameter of the part of the roll-off piston on which the lower rolling lobe rolls off. The advantage of this feature is that, with a configuration of this kind of the cover and of the roll-off piston of the air spring, it can be ensured, in a simple manner, that the upper rolling lobe lies against the cover of the air spring over a portion of the spring path of the air spring.

According to another feature of the invention, the cover of the air spring contains at least one recess facing toward the shock absorber wherein the upper rolling lobe lies. Preferably, the contour of the recess or recesses is adapted to the contour of the upper rolling lobe. The advantage of this feature is that the upper rolling lobe of the flexible member can move in these recesses without deforming when the air spring is pivoted relative to the shock absorber in the pivoting direction.

According to still another feature of the invention, the upper end portion of the flexible member is attached to the cover with a clamping ring. The advantage of this feature is that an attachment with a clamping ring is simple. The lower end portion of the flexible member can likewise be attached with a clamping ring.

According to another feature of the invention, the attachment is such that the upper end portion of the flexible member slings over the clamping ring. The advantage of this embodiment is that the slung-over clamping at the upper region of the flexible member leads to a reduction of the load on the clamping connection because a force directed radially outwardly (which comes from the air pressure in the air spring) does not load the clamping connection but only “attempts to lift off” the upper rolling lobe radially outwardly from the clamping ring. The lower end of the flexible member can be attached with a clamping ring to the roll-off piston in the same manner so that the lower end portion of the flexible member is slung over the clamping ring. In this way, the same advantage is achieved as at the upper end of the flexible member.

According to another feature of the invention, the flexible member is surrounded at least over a region thereof by an outer guide. The advantage of this feature is that the outer guide can take up radial forces which operate on the flexible member and, for this reason, the flexible member can be configured so as to be thin. With a thin-walled configuration of the flexible member, excellent spring comfort of the air spring is achieved because the air spring has no tendency to harden with small vibration amplitudes. Preferably, the outer guide is cylindrical because a cylindrical outer guide is easy to manufacture.

According to another feature of the invention, the air spring includes a roll-off piston which is supported on the cylinder of the shock absorber. The advantage of this feature is that the contour of the roll-off piston is directly adapted to the desired configuration of the rolling lobe and that the air spring can be manufactured completely and independently of the shock absorber. A further advantage of this feature is that the roll-off piston of the air spring can be supported for wobble movement on the cylinder of the shock absorber so that, in this region, an additional pivotability of the air spring relative to the shock absorber is provided.

According to another feature of the invention, the lower rolling lobe of the air spring is attached to the cylinder of the shock absorber. In this embodiment, the cylinder is used at least partially as a roll-off piston for the flexible member of the air spring. The advantage of this feature is that a separate roll-off piston for the air spring is not needed and a component is saved.

### BRIEF DESCRIPTION OF THE DRAWINGS

The invention will now be described with reference to the drawings wherein:

FIG. 1 is a side elevation view, partially in section, of an air spring strut according to an embodiment of the invention;

FIG. 2 is a section view taken along line II-II of FIG. 1; and,

FIG. 3 is a side elevation view, partially in section, of an air spring strut according to another embodiment of the invention.

### DESCRIPTION OF THE PREFERRED EMBODIMENTS OF THE INVENTION

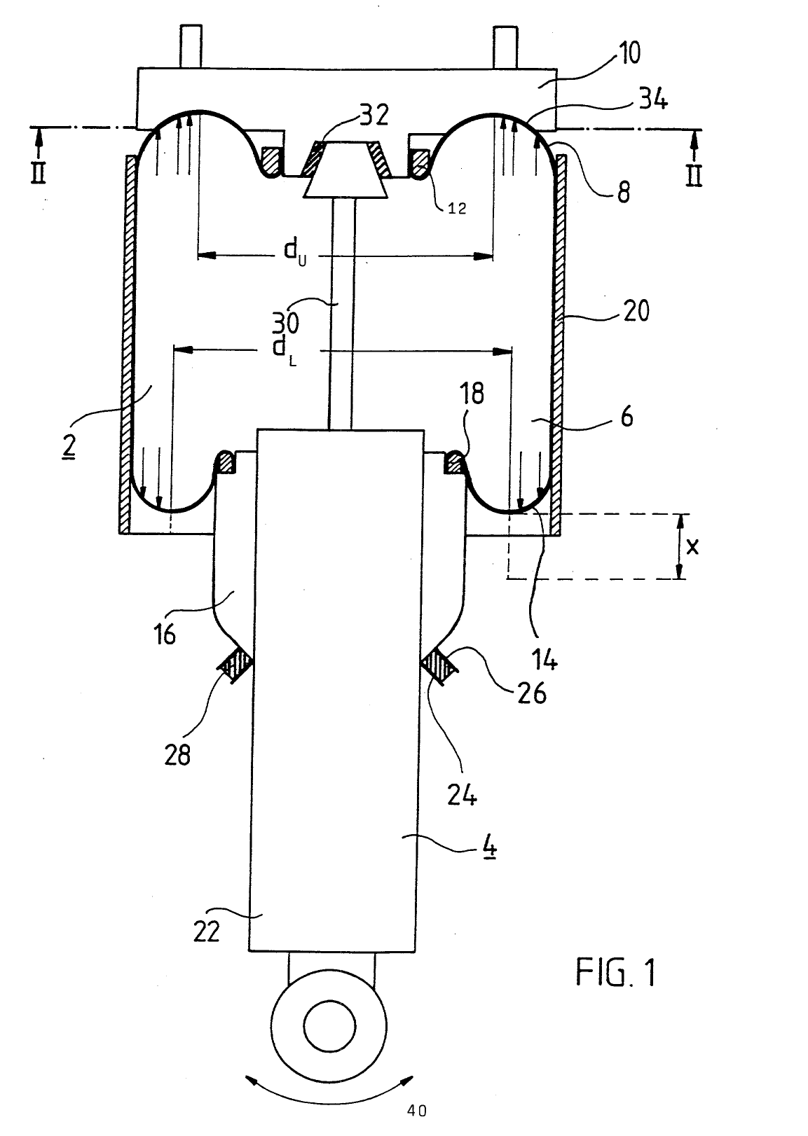

FIG. 1 shows a shock absorber and air spring assembly or air spring strut having an air spring 2 and a shock absorber 4. The air spring 2 includes a flexible member 6 whose upper end is attached to the cover 10 of the air spring 2 while forming an upper rolling lobe 8. The attachment is made with the aid of a clamping ring 12. Clamping is provided in such a manner that the flexible member 6 between the clamping ring 12 and the cover 10 is directed away from the cover 10 (that is, the flexible member is orientated toward the lower end of the air spring strut). After the region between the clamping ring 12 and the cover 10, the flexible member 6 is transferred in the direction of the cover 10 into the upper rolling lobe 8 so that the flexible member 6 slings over the clamping ring 12.

The lower end of the flexible member 6 is attached to the roll-off piston 16 of the air spring 2 while forming a lower rolling lobe 14. The attachment is made with the aid of a clamping ring 18 over which the flexible member 6 slings in the same manner as for the clamping ring 12. The flexible member 6 of the air spring 2 encloses an air volume filled with air under pressure and is surrounded by a cylindrically-shaped outer guide 20. The outer guide 20 can be made of metal or plastic and prevents too great a radial expansion of the flexible member 6. The outer guide 20 can, for example, be attached to the flexible member 6 via a frictional grip.

A contact engagement of the upper rolling lobe 8 on the cover 10 of the air spring 2 is ensured in that the pressure-effective diameter d_{U} of the upper rolling lobe 8 is less than the pressure-effective diameter d_{L} of the lower rolling lobe 14. In this way, the air pressure in the air spring 2 acts on a larger area for the upper rolling lobe 8 than for the lower rolling lobe 14. Here, only the area, which lies outside of the pressure-effective areas, makes a contribution. As a consequence, the force, which acts on the upper rolling lobe 8 and is directed upwardly, is greater than the force, which acts on the lower rolling lobe and is directed downwardly, so that the upper rolling lobe 8 comes into contact engagement with the cover 10 of the air spring 2. For a specific spring state of the air spring strut 2, the pressure-effective area d_{U} is less than the pressure-effective area d_{L} when, for this spring state, the diameter of the cover 10 (on which the upper rolling lobe 8 rolls off) is less than the diameter of the part of the roll-off piston 16 on which the lower rolling lobe 14 rolls off. In the air spring strut shown in FIG. 1, this is the case for the entire spring path (x) of the air spring 2 so that it is ensured that the upper rolling lobe 8 lies against the cover 10 for a plunging of the roll-off piston 16 into the air volume of the air spring 2 over the entire spring path (x).

The roll-off piston 16 of the air spring 2 is supported on the cylinder 22 of the shock absorber 4. For this purpose, the cylinder 22 can have, for example, a flange-like projection 24 on which the flange-like end 26 of the roll-off piston 16 is supported. A ring 28 of elastomeric material is mounted between the flange-like projection 24 of the shock absorber 4 and the flange-like end 26 of the roll-off piston 16.

It is likewise possible to attach the roll-off piston 16 in another manner to the cylinder 22 of the shock absorber 4, for example, rigidly. A piston rod 30 is introduced into the cylinder 22 of the shock absorber 4 and a piston (not shown) is attached to this piston rod. The piston rod 30 is connected to the cover 10 of the air spring 2 via an elastomeric support 32. For a pivoting or swinging of the shock absorber 4 relative to the air spring 2 in the direction of arrow 40, the upper rolling lobe 8 of the air spring 2 operates as an elastic support which does not resist this pivoting of the shock absorber 4. During the pivoting, the upper rolling lobe 8 moves back and forth in the recesses 34 of the cover 10. With the pivotability, it is ensured that the piston rod 30 and the cylinder 22 are always aligned along an axis.

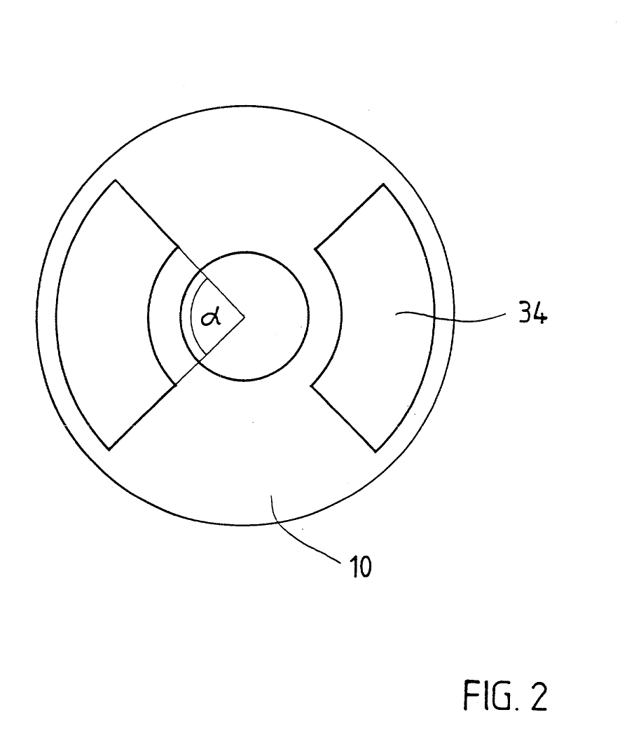

FIG. 2 shows a section through the air spring strut along line II-II of FIG. 1. The flexible member 6 is not shown for the sake of clarity. From FIG. 2, it can be seen that the recesses 34 in the cover 10 extend over respective angles a which lie between 60° and 90°.

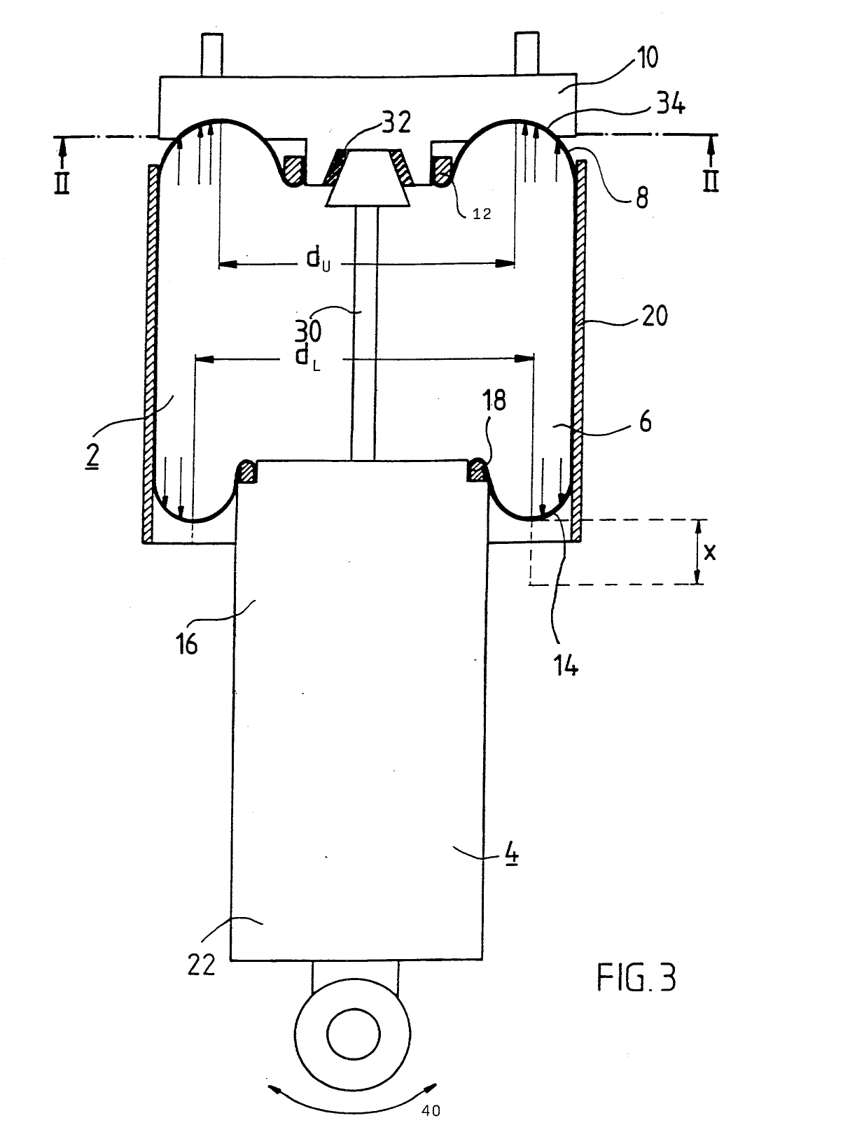

FIG. 3 shows an air spring strut which is substantially configured like the air spring strut shown in FIG. 1. The only difference is that the lower rolling lobe 14 is attached directly to the cylinder 22 and the upper part of the cylinder 22 is used directly as a roll-off piston for the flexible member 6 of the air spring 2.

It is understood that the foregoing description is that of the preferred embodiments of the invention and that various changes and modifications may be made thereto without departing from the spirit and scope of the invention as defined in the appended claims.

What is claimed is:

1. A shock absorber and air spring assembly comprising:
an air spring including: a cover, a roll-off piston; and, a flexible member having a lower end portion attached to said roll-off piston to form a lower rolling lobe and an upper end portion attached to said cover so as to form an upper rolling lobe;
said flexible member enclosing a volume of air and deflecting over a spring path during operation of said assembly;
a shock absorber interposed between said cover and said roll-off piston; and,
at least a region of said upper rolling lobe being in contact engagement with said cover over at least a portion of said spring path so as to cause said upper rolling lobe to define an elastic element facilitating a pivoting of said air spring relative to said shock absorber over said portion of said spring path.

2. The shock absorber and air spring assembly of claim 1, said cover having a portion on which said upper rolling lobe rolls off during operation of said assembly; and, said portion of said cover having a diameter less than the diameter of said part of said roll-off piston on which said lower rolling lobe rolls off on.

3. The shock absorber and air spring assembly of claim 2, said cover having at least one recess in which said upper rolling lobe lies.

4. The shock absorber and air spring assembly of claim 3, further comprising a clamping ring for attaching said upper end portion of said flexible member to said cover.

5. The shock absorber and air spring assembly of claim 4, wherein the attachment of said upper end portion of said flexible member is so configured that said upper end portion is slung over said clamping ring.

6. The shock absorber and air spring assembly of claim 1, further comprising an outer guide embracing at least a portion of said flexible member.

7. The shock absorber and air spring assembly of claim 1, wherein said shock absorber includes a cylinder and said roll-off piston is supported on said cylinder.

8. The shock absorber and air spring assembly of claim 1, wherein said shock absorber includes a cylinder and said lower end portion is attached to said cylinder so that said cylinder defines said roll-off piston.
